(19) United States
(12) Patent Application Publication
(10) Pub. No.: US 2004/0249827 A1
(43) Pub. Date: Dec. 9, 2004

(54) System and method of retrieving a range of rows of data from a database system

(75) Inventors: Kulvir Singh Bhogal, Fort Worth, TX (US); Richard Dale Hoffman, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 10/455,181

(22) Filed: Jun. 5, 2003

(51) Int. Cl. G06F 7/00

(52) U.S. Cl. 707/100

(57) ABSTRACT

A system and method of retrieving a range of rows of data from a database system are provided. When data is needed from the database system a query for the data is sent. The query includes a first request to generate a return table having a plurality of rows of data and a second request for selecting and returning rows n to m from the plurality of rows of data, n and m being integers. In a particular embodiment, the query is a Structured Query Language (SQL) query. Further, the range of data may be from row one (1) to row n, from row n to the last row or from row n to row m of the returned table.

### BACKGROUND OF THE INVENTION

1. Technical Field

The present invention is directed to executing queries to retrieve data from a database system. More specifically, the present invention is directed to a system and method of executing queries to retrieve a range of rows of data from a database system.

2. Description of Related Art

A database system is a computerized data storage and retrieval system. To manage the data in a database system, a database management system (DBMS) is used. A DBMS is a collection of programs that enables a user to enter, organize, and retrieve data from a database system.

Requests for information from a database system are generally made in the form of a query using a query language. Different DBMSs have different query engines that support different query languages. (A query engine is a search engine that searches a database system using keywords or phrases entered by a user.) However, one query language (i.e., Structured Query Language or SQL) has become standard since it has been adopted by both the American National Standards Organization (ANSI) and the International Standards Organization (ISO).

When a user sends an SQL query to a database system, the query is executed and a result returned. The result ordinarily comprises a set of rows and columns as results are generally returned in the form of tables. If the user desires that the rows be returned in a particular order, the user must specify the order by including an ORDER BY clause in the query. For example, the rows may be returned in ascending or descending order by using the keyword ASC or DESC for ascending or descending, respectively as a qualifier to the ORDER BY clause. Thus, if the user wants the rows returned in descending order, the user has to qualify the ORDER BY clause with the keyword DESC. Note that if the ORDER BY clause does not have a DESC or ASC qualifier the result will be in ascending order, the default order.

A user who requests ordered data may desire that only a subset of the result be returned. Presently, a user may only specify that the top n rows of a result table be returned. For example, in DB2 (DB2 is a product of International Business Machines), a user may do so by using the clause “OPTIMIZE FOR n ROWS” n being an integer. Thus, if a user is interested in median calculations or in experimental data analyses, and thus only wants a middle subset of a result returned, the whole result table may have to be transmitted to the user. The user then may either have to scroll manually through the result to discard unwanted rows or have a program do so.

Consequently, a need still exists for a system and method of limiting a query result to a sub-range that comprises rows n to m or the last n rows, where n and m are integers.

### SUMMARY OF THE INVENTION

The present invention provides a system and method of retrieving a range of rows of data from a database system. When data is needed from the database system a query for the data is sent. The query includes a first request to generate a return table having a plurality of rows of data and a second request for selecting and returning rows n to m from the plurality of rows of data, n and m being integers. In a particular embodiment, the query is a Structured Query Language (SQL) query. Further, the range of data may be from row one (1) to row n, from row n to the last row or from row n to row m of the returned table.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts a table T of salary data of a company.

FIG. 5 depicts a first result table R of a query.

FIG. 6 depicts a second result table R of a query.

FIG. 7 depicts a flow diagram of a process that may be used by the invention.

FIG. 8 illustrates an exemplary database table and database index.

### DETAILED DESCRIPTION OF THE PREFERRED EMBODIMENT

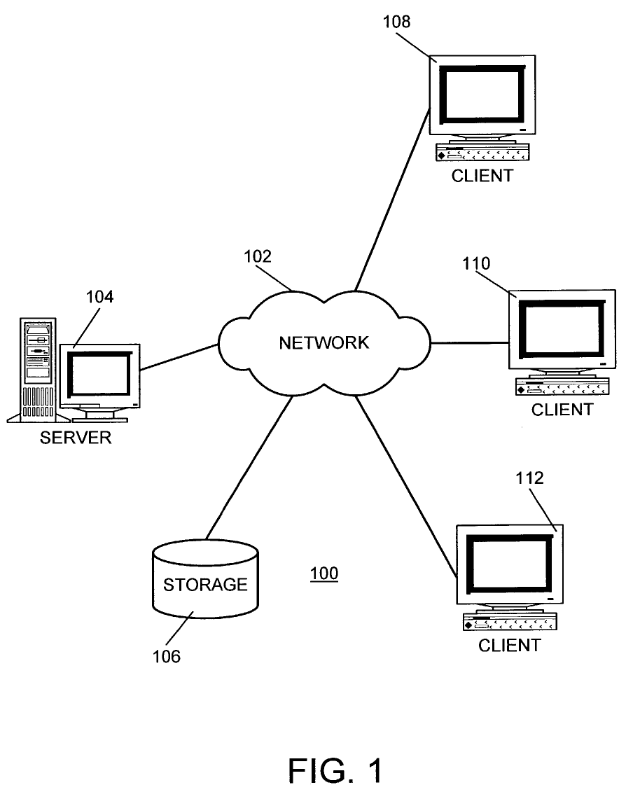

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

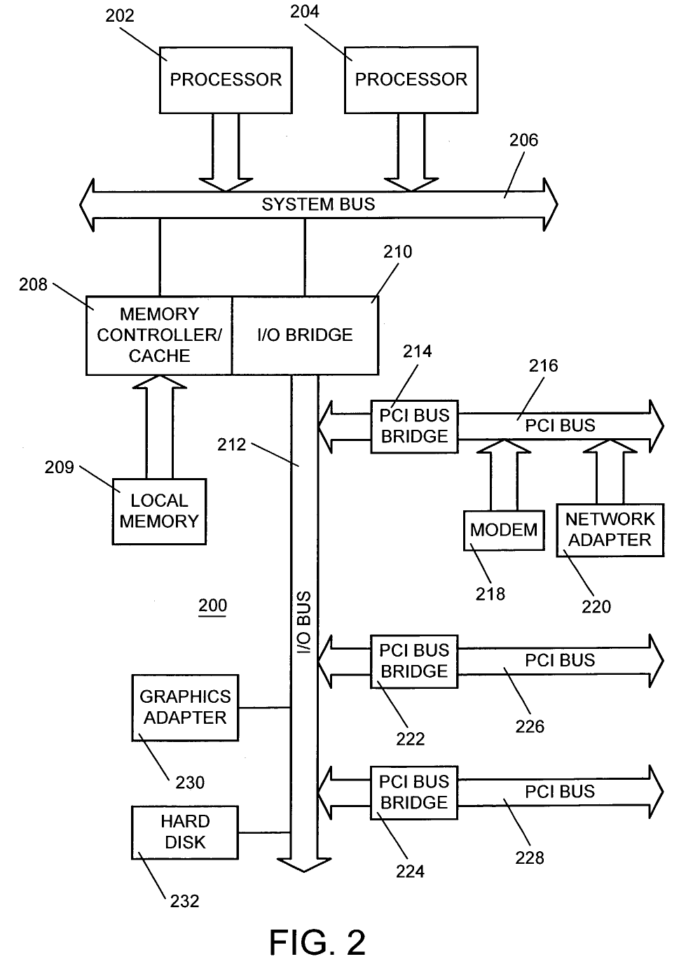

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

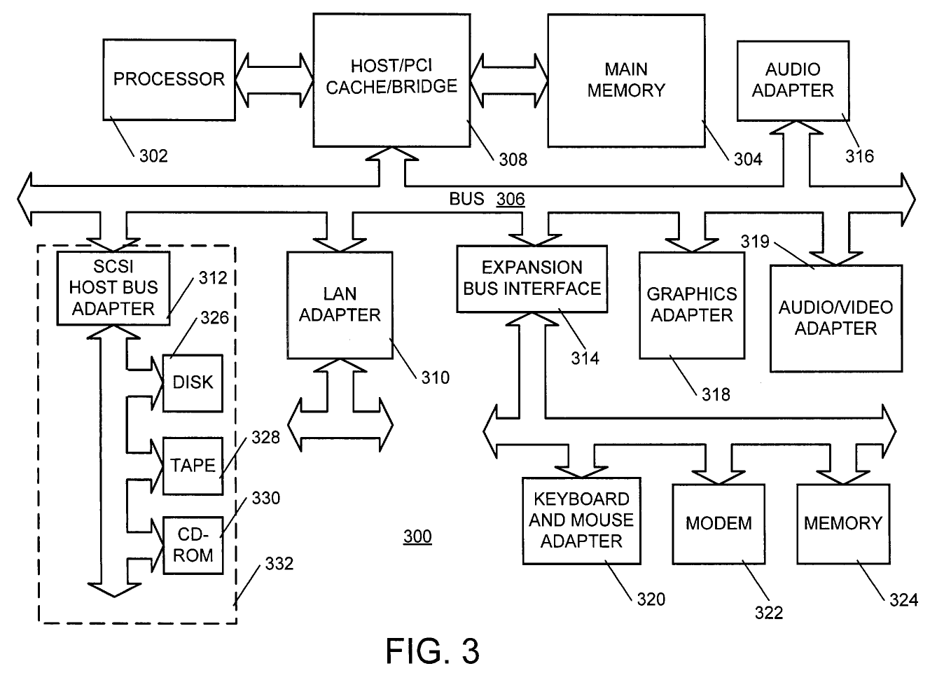

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system and method of retrieving a range of rows of data from a database system. The invention is preferably local to the server 104. Further, the present invention may reside on any data storage medium (i.e., floppy disk, compact disk, hard disk, ROM, RAM, etc.) used by a computer system.

One of the most common SQL queries executed by a DBMS query engine is the SELECT statement. In the SQL standard, the SELECT statement has the general format: “SELECT<clause> FROM<clause> WHERE<clause> GROUP BY<clause> HAVING<clause> ORDER BY <clause>.” The clauses must follow this sequence. However, only the SELECT and FROM clauses are required. All other clauses are optional.

The result of a SELECT statement is a subset of data retrieved by the DBMS query engine from one or more existing tables stored in the database system, wherein the FROM clause identifies the name of the table or tables from which data is to be selected. The subset of data is treated as a new table, termed the result table.

The WHERE clause determines which rows should be returned in the result table. Specifically, the WHERE clause contains a search condition that must be satisfied by each row contained in the result table. The rows that meet the search condition form an intermediate set, which is then processed further according to other specifications in the SELECT statement. The search condition may comprise one or more predicates, each of which may specify a comparison between two values from certain columns, constants or correlated values. Multiple predicates in the WHERE clause are connected by Boolean operators.

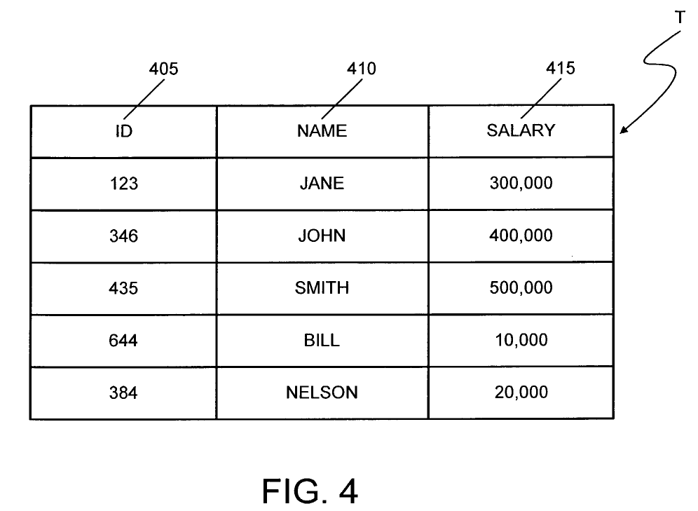

FIG. 4 depicts a table T of salary data of a company which may be stored on a data storage medium of server 104. The table has an ID column 405, a NAME column 410 and a SALARY column 415. An identification number for each employee of the company is stored in the ID column 405. The name of each employee is stored in the NAME column 410 and their salary in the SALARY column 415.

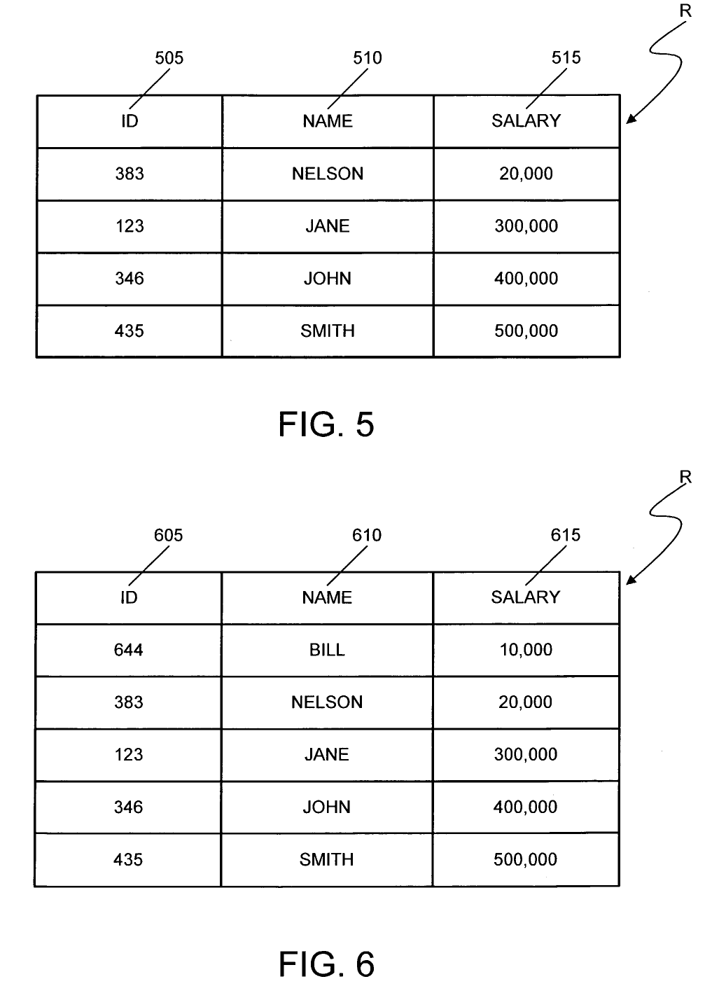

The following query: SELECT * FROM T WHERE SALARY>10,000 ORDER BY SALARY instructs the query engine to perform the search on the salary column of table T and to use the value in the salary column when ordering the return table. Accordingly, each row of table T whose salary value is greater than 10,000 will be included in the return table. Hence, FIG. 5 will be returned. As mentioned before, the result of the query is organized as a table (i.e., return table R). The table R contains ID column 505, NAME column 510 and SALARY column 515. As in the case of FIG. 4, the identification number of each employee in table R is in the ID column 505. Likewise, the name of each employee is in the NAME column 510 and the salary of the employees in SALARY column 515. Note however that the rows are in ascending salary order, the default order of an ORDER BY clause without an ASC or DESC qualifier.

If a user wants the salary of every employee returned, the user may use the following query: SELECT * FROM T WHERE SALARY>0 ORDER BY SALARY. The result of that query is depicted in FIG. 6. FIG. 6 is identical to FIG. 4, except that FIG. 6 is arranged in ascending SALARY order and FIG. 4 is not arranged in any particular order except perhaps the order in which the data was entered in the database system.

Now suppose the salary of all the employees in a company's payroll is entered into table T of FIG. 4. Suppose further that a user knows the number of employees who are employed by the company. Then, the user will most probably know how many rows there will be in table R when the query: SELECT * FROM T WHERE SALARY>0 ORDER BY SALARY is used. In the case of the example above, the user will most probably know that table R will contain five (5) rows, one row for each employee.

Hence, if the user were to be interested only in the company's median salary, the user would only be interested in row 3 of the table. As mentioned previously, there is not presently any particular method of retrieving only row 3 of the table R of FIG. 6. Therefore, either the entire table R or the top three (3) rows of FIG. 6 will have to be retrieved and the user will have to discard all the rows but row 3. Clearly, depending on the number of employees on the company's payroll, this could be quite a time-consuming task.

The present invention allows one to specify the rows of a query result that are to be returned. According to an embodiment of the invention after an ORDER BY <clause> is entered in a query, a RETURN ONLY <clause> may be entered. The RETURN ONLY <clause> may include “TOP n ROWS”, “LAST n ROWS” and “ROWS n TO m”. The “TOP n ROWS” clause is used if only the first n rows of the return table are to be returned. If, instead, the last n rows are to be returned, then the “LAST n ROWS” clause is to be used. In the case where rows n to m are to be returned the clause “ROWS n TO m” is to be used. Further, if the top n rows and the last m rows are to be returned, then the two clauses “TOP n ROWS” and “LAST m ROWS” may be used.

Thus, the query SELECT * FROM T WHERE SALARY>0 ORDER BY SALARY RETURN ONLY ROWS n TO m will return a range of rows starting from row n to row m, n and m being integers. Specifically, a return table such as the table depicted in FIG. 6 will first be constructed. From the constructed return table rows n to m will be returned.

In the case where a user wants the median salary from table R of FIG. 6, the following query Q may be used: SELECT * FROM T WHERE SALARY>0 ORDER BY SALARY RETURN ONLY ROWS 3 TO 3. Accordingly, table R of FIG. 6 would first be generated and from the generated table R row 3 would be returned to the user. Note that in this case since only one row is to be returned then n=m=3.

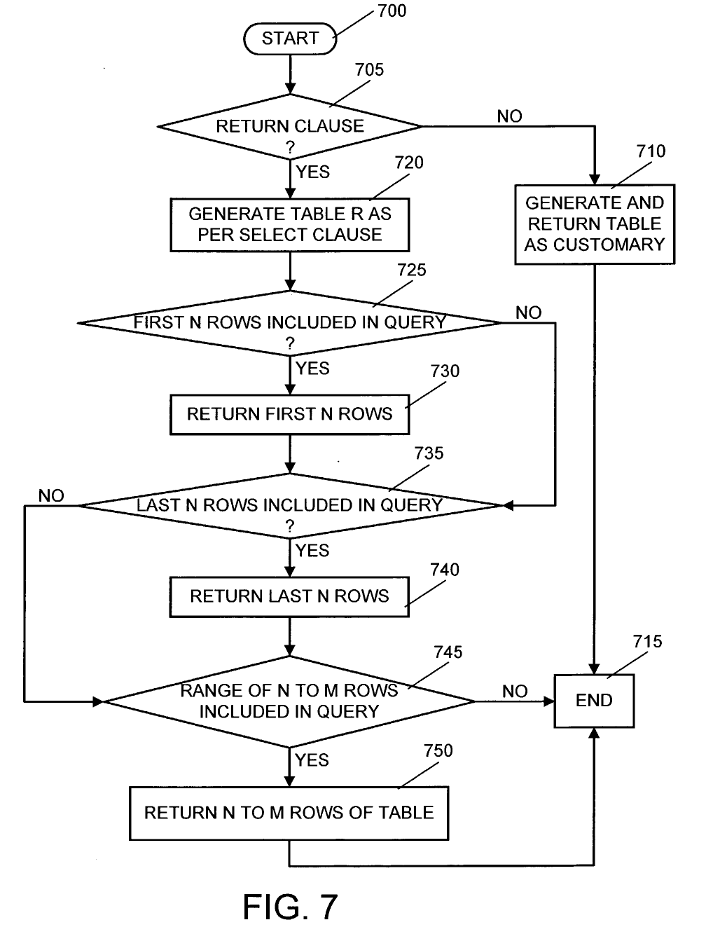

FIG. 7 depicts a flow chart of a process that may be used to implement the invention. The process may be a stored procedure implemented in C, C++, Java (a trademark of Sun Microsystems, Inc.) or any other programming language. A stored procedure is a set of SQL statements with an assigned name that is stored in the database in compiled form so that it can be shared by a number of programs. The use of stored procedures can be helpful in controlling access to data (end-users may enter or change data but do not write procedures), preserving data integrity (information is entered in a consistent manner), and improving productivity (statements in a stored procedure only need to be written once).

In any case, the process starts as soon as a query is received (step 700). Then a check will be made to determine whether the query contains a RETURN ONLY clause. If not, the query will be processed as customary (i.e., a table R will be generated and returned) before the process ends (steps 705, 710 and 715).

If there is a RETURN ONLY clause in the query, then a table R will be generated as per a SELECT statement or whatever other statements there are in the query. Then a check will be made to determine whether the RETURN ONLY clause contains a “FIRST n ROWS”, LAST n ROWS and/or ROWS n TO m clause. If the “FIRST n ROWS” clause is present, the first n rows of the table R will be returned. Likewise, if the “LAST n ROWS” or both the “FIRST n ROWS” and “LAST m ROWS” are present, the last n rows or both the first n rows and last m rows will be returned. If the “ROWS n TO m” clause is present, then rows n to m of the table R will be returned. Then, the process ends (steps 705, 720, 725, 730, 735, 740, 745, 750 and 715).

One advantage of the invention is convenience. That is, in the past the whole table R had to be generated and transmitted to the user. The user then had to discard unwanted rows. Using the invention, however, only the rows in which the user is interested will actually be transmitted to the user.

Another advantage of the invention is in network traffic. As mentioned above, in the past the whole table R had to be transmitted over the network. However, using the present invention and depending on the size of m+1−n, there could be a significant decrease in network traffic. For instance, only one row will be transmitted when n=m.

A further advantage is that under certain conditions, the query engine may be able to take advantage of the [n,m] restriction to actually do less work. A simple example is when the median salary of a group of employees is needed. If the salary field is indexed, the query engine may know the total size of the employee table (i.e., the size of the index table). Consequently, the query engine may directly access the row containing the median value without first generating table R. Thus, the value needed may be retrieved in one operation.

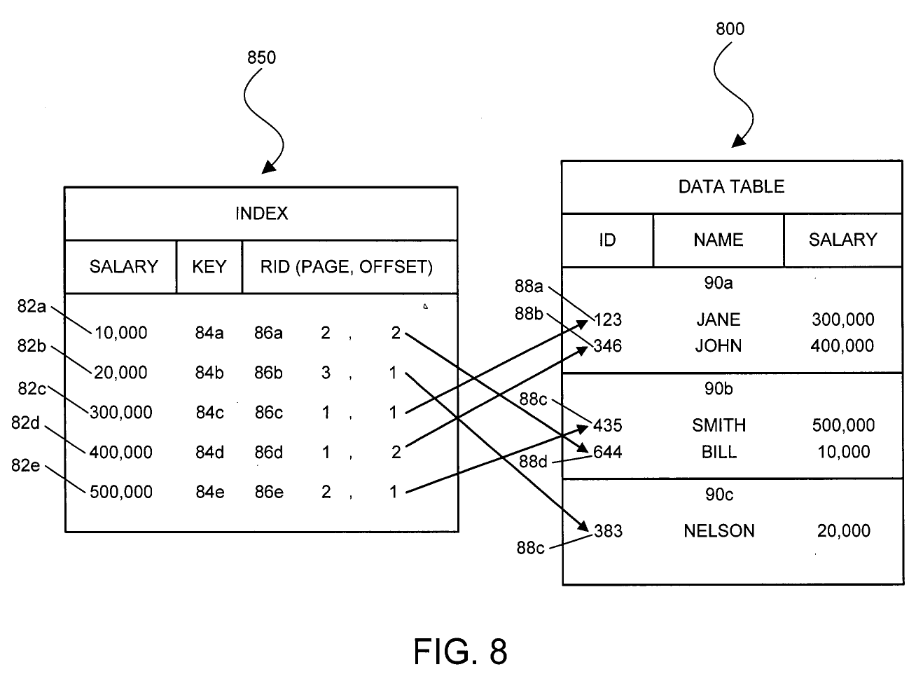

To illustrate, FIG. 8 shows an exemplary database table 800 and database index 850. The database table 800 comprises five rows 88 of data, each row 88 is shown individually as 88a, 88b, 88c, 88d and 88e. The rows 88 are stored over three pages 90, indicated individually as 90a, 90b and 90c in FIG. 8.

The index table 850 comprises an ordered list of entries 82, indicated individually as 82a, 82b, 82c, 82d and 82e. Each index entry 82 includes an index key value 84 (shown individually as 84a, 84b, 84c, 84d and 84e) and a row identifier or RID 86 (shown individually as 86a, 86b, 86c, 86d and 86e). Each RID 86 comprises a disk address or page number and an offset. A pointer from each of the rows in the index table points to a corresponding row in the data table 800.

As shown in FIG. 8, the entries 82 in the index table 850 are listed in increasing (ascending) SALARY amount. Since the indexes are ordered, it is convenient to consecutively number the index entries 82. It will be appreciated that the numbers for the index entries 82 are not physically stored in the index table 850, but are assigned when the entire index table 850 is scanned into memory. These numbers for the index entries 82 will be referred to as ranks. For example, the third index entry 82c in the index table 850 has a rank 3.

Hence, when the index table 850 is scanned into memory, the number of rows in the table will be known since it will be equal to the rank of the last index entry 82e. Consequently, when a user requests “ROWS n TO m, if n=m then the row to which the pointer from (rank/2)^{th} salary entry points may automatically be retrieved without first generating a table R. In the example above, (rank/2)^{th} salary entry is salary entry 82c (i.e., 5/2=2.5 rounded up to 3). Thus, the first row in database table 800 will be retrieved and transmitted.

The description of the present invention has been presented for purposes of illustration and description, and is not intended to be exhaustive or limited to the invention in the form disclosed. Many modifications and variations will be apparent to those of ordinary skill in the art. For example, the query may be in the form: SELECT * FROM T WHERE SALARY>0 ORDER BY SALARY ONLY FIRST n ROWS|LAST n ROWS|ROWS n TO m instead of: SELECT * FROM T WHERE SALARY>0 ORDER BY SALARY RETURN ONLY FIRST n ROWS|LAST n ROWS|ROWS n TO m. In this case, since the ONLY FIRST n ROWS|LAST n ROWS|ROWS n TO m clauses are new, the DBMS software can either change or execute the query as if it were SELECT * FROM T WHERE SALARY>0 ORDER BY SALARY RETURN ONLY FIRST n ROWS|LAST n ROWS|ROWS n TO m.

Hence, the embodiment was chosen and described in order to best explain the principles of the invention, the practical application and to enable others of ordinary skill in the art to understand the invention for various embodiments with various modifications as are suited to the particular use contemplated.

What is claimed is:

1. A method of retrieving a range of rows of data from a database system comprising the steps of:
transmitting a query to the database system, the query including a first request to generate a return table having a plurality of rows of data and a second request for selecting and returning rows n to m from the plurality of rows of data, n and m being integers; and
receiving the returned rows n to m.

2. The method of claim 1 wherein the query is a Structured Query Language (SQL) query.

3. The method of claim 2 wherein if m=n, then one row of data is returned.

4. The method of claim 3 wherein when m=n and part of the data is in an index table, the index table is used to return the one row of data without first generating the return table.

5. The method of claim 2 wherein the range of data is from row zero (0) to row n.

6. The method of claim 2 wherein the range of data is from row n to the last row in the returned table.

7. The method of claim 2 wherein the range of data is from row zero (0) to row n and from row m to the last row of the returned table.

8. A computer program product on a computer readable medium for retrieving a range of rows of data from a database system comprising:
code means for transmitting a query to the database system, the query including a first request to generate a return table having a plurality of rows of data and a second request for selecting and returning rows n to m from the plurality of rows of data, n and m being integers; and
code means for receiving the returned rows n to m.

9. The computer program product of claim 1 wherein the query is a Structured Query Language (SQL) query.

10. The computer program product of claim 9 wherein if m=n, then one row of data is returned.

11. The computer program product of claim 10 wherein when m=n and part of the data is in an index table, the index table is used to return the one row of data without first generating the return table.

12. The computer program product of claim 9 wherein the range of data is from row zero (0) to row n.

13. The computer program product of claim 9 wherein the range of data is from row n to the last row in the returned table.

14. The computer program product of claim 9 wherein the range of data is from row zero (0) to row n and from row m to the last row of the returned table.

15. A computer system for retrieving a range of rows of data from a database system comprising:
at least one storage system for storing code data; and
at least one processor for processing the code data to transmit a query to the database system, the query including a first request to generate a return table having a plurality of rows of data and a second request for selecting and returning rows n to m from the plurality of rows of data, n and m being integers, and to receive the returned rows n to m.

16. The computer system of claim 15 wherein the query is a Structured Query Language (SQL) query.

17. The computer system of claim 16 wherein if m=n, then one row of data is returned.

18. The computer system of claim 17 wherein when m=n and part of the data is in an index table, the index table is used to return the one row of data without first generating the return table.

19. The computer system of claim 16 wherein the range of data is from row zero (0) to row n.

20. The computer system of claim 16 wherein the range of data is from row n to the last row in the returned table.
